(19) United States
(12) Patent Application Publication
(10) Pub. No.: US 2026/0111804 A1
(43) Pub. Date: Apr. 23, 2026

(54) CLIMATE EFFICIENT ELECTIC VEHILCE CHARGING OPTIMIZATION, SCHEDULING AND THROUGHPUT SYSTEMS, AND METHODS AND APPARATUS THEREFOR

(71) Applicant: Oodles Energy, Naples, FL (US)

(72) Inventors: Paul S. Efron, Naples, FL (US); Keith Berger, Marietta, GA (US)

(21) Appl. No.: 18/920,279

(22) Filed: Oct. 18, 2024

(51) Int. Cl. G06Q 10/02

(52) U.S. Cl. CPC G06Q 10/02

(57) ABSTRACT

Systems and methods directed to scheduling and reserving charging ports are disclosed. In one embodiment, a reservation system is provided permitting a user to reserve all or part of a charging time slot on a particular charging dispenser. The reservation system includes a computer comprising a processor and a memory. The processor is configured to send a first message comprising a request for a reservation for an available charging port. The processor is further configured to detect the availability of available charging ports, present available charging ports, and reserve a charging port.

### FIELD OF THE INVENTION

The present invention relates generally to climate-friendly EV charging management and scheduling systems, more specifically, to systems, methods and apparatus for increasing utilization, efficiency and thereby climate-friendly use of EV charging apparatus and integrating systems, infrastructure and logistics to reduce charging-times and alleviate space-constraint and capacity issues associated with EV charging in non-single family dwelling and self-parking locations, including apartments, hotels and travel destinations.

### BACKGROUND

The lack of available charging infrastructure presents a major impediment to the adoption of EVs for everyday use, including travel and range. Adoption of EV's is of major importance to the environment in the reduction of greenhouse gases from combustion engine-powered use because EV adoption and use has been shown to lower emissions by powering vehicles with stored energy from batteries versus combustion engines which are known to emit CO2, ozone and other greenhouse gases which are detrimental to the atmosphere and climate. Increasing EV adoption and use not only improves air quality locally, but results in the reduction of greenhouse gases, point source pollution and overall aids in the mitigation of climate change. Generally, commercial charging stations are known to be more energy efficient than so called ‘at home’ and as such increased availability and efficient use of capacity provided in turn minimizes global energy waste, increases clean-energy adoption and lowers undesirable environmental footprints.

Specifically, even where capacity is available, constraints to efficient use of commercial charging infrastructure exist on several fronts. For one, the ability to charge EVs at home for individuals who do not live in single family or standalone dwellings by definition limit available capacity to the general public. In addition, the lack of charging station availability away from residencies including while traveling distances in one's personal vehicle chills adoption and use.

To address these limitations, it is advantageous for apartment buildings and hotels to offer adequate, available ad accessible charging facilities for their tenants and guests. The availability of on-premises charging for EVs as such will increase consumer desire for the facility occupancy and EV use for travel with increasing range, including but not limited to day rates for hotels and rents for apartment owners. Consumer behavior has shown that EVs drivers generally do not favor going to public charging stations to charge their vehicles over charging facilities associated within their more local residence or tenancy.

In multi-family buildings, efficient on-premises charging capacity and availability is presently lacking. Hotels and housing other than single family dwellings can and should be an accessible part of the overall EV charging infrastructure, particularly for travelers who desire the convenience of charging when they arrive at their destination. Also, apartment dwellers and hotel guests may prefer to be able to charge their EVs on premises rather than being left to their own devices to find and then travel to off-premises and/or unfamiliar charging destinations and then, upon arrival wait additionally at inconvenient, off premises/public charging stations.

Generally, two types of charging systems exist: AC charging and DC charging. AC chargers can generally recharge an EV battery system in about 5-7 hours' time using 208 volt power while DC chargers currently optimized by the present invention can charge a car in about 20 minutes time using 480 volt power. Accordingly, AC charging systems therefore are constrained in their ability to charge large numbers of vehicles since the electrical capacity for most buildings significantly limits the number of AC chargers that can be operated at any given time. Additionally, the cost of expanding building electrical capacity is typically prohibitive. In contrast, rapid chargers such as DC chargers can handle many more vehicles simultaneously or near simultaneously, but throughput can generally only realized if the vehicles to be charged can be efficiently moved in and out of available charging slots.

An additional challenge for a majority of large building facilities is need for human labor, including employees and/or contractors to valet the vehicles out of charging slots when the vehicle has been fully charged. As such, the promise of charging large volumes of vehicles and increasing throughput to take advantage of the shorter DC charging times, and achieving climate benefits cannot be fully realized unless the facility provides a system which addresses the so-called and increasingly prevalent ‘overstay’ problem: that is, customers who fail to move their vehicle when their charging session has been completed. Without such systems, the installation of DC chargers (which are substantially more expensive than AC chargers) becomes much less effective solution for the building. The system, method, and apparatus of the instant invention for managing charging logistics, including by way of example but not limited to “self-parking” buildings, is needed to realize the advantages of rapid and available charging and hence provide a more robust and efficient charging infrastructure for EV driver use and charging availability and efficiency to realize climate benefits. Even where facility owners look or undertake to install as many AC chargers as their electrical system will permit, the cost of such a solution is much higher and indeed energy efficiencies and environmental benefits are lost as a multitude of AC chargers, aside from the cost, typically requires the need for a massive overhaul of the electrical infrastructure in the building.

Still, while other logistical solutions are being contemplated (such as pallets that automatically move cars in and out of charging stations in garages), these solutions are unproven and likely to be far more expensive and capital intensive as compared to the present invention. In addition, logistical solutions that do not improve charging efficiency fail to better the environment in contrast to the instant invention.

### BRIEF SUMMARY OF THE INVENTION

A need therefore exists for an apparatus, system, and method to optimize efficient charging for electric vehicles through computer implemented integration of facility charging apparatus including rapid charging and driver availability and efficient scheduling mechanisms. The system, method and apparatus of providing the integrations of the instant invention for managing charging logistics, capacity and excess capacity, particularly among “self-parking” buildings and multi-resident dwellings, is needed to realize the advantages of rapid and available charging and hence providing a more robust and efficient charging infrastructure for EV driver use and increasing the adoption and use of EVs to help reduce carbon emissions, improve air quality and mitigate climate change.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

The figures depict embodiments for purposes of illustration only. One skilled in the art will readily recognize from the following discussion that alternative embodiments of the systems and methods illustrated herein may be employed without departing from the principles of the invention described herein.

FIG. 1 illustrates the various interactions in one embodiment of the reservation system with charging station hardware 660 vehicle100 and driver 105.

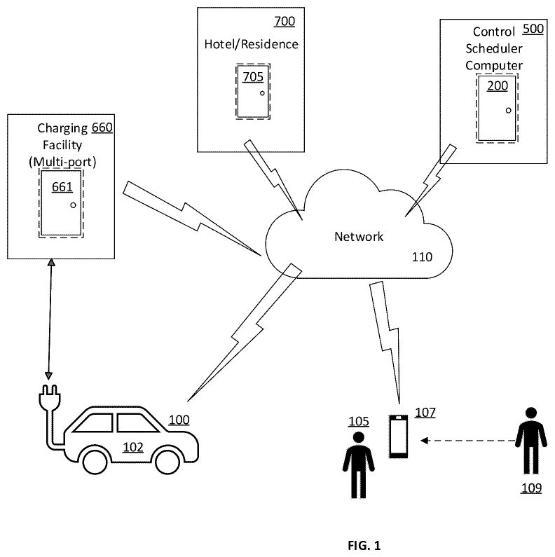

FIG. 2Ais illustrative of the reservations and charging optimization steps of the present invention including obtaining a reservation, the driver's arrival at charging port at the facility, initiation of charging session and charging completion 200.

FIG. 2B shows some exemplary systems components and their integration in accordance with an embodiment of the disclosure.

FIG. 3 shows exemplary event monitoring components and integration with an embodiment of the disclosure.

FIG. 4 illustrates a scenario where the vehicle is in an overstay condition following the expiry of the charging session and/or reservation time.

FIG. 5 shows some example components that may be included in a computer of the control scheduler computer 500 in accordance with an embodiment of the disclosure.

FIG. 6 shows some example components that may be included in a computer of a facility having one or more EV charging apparatus 600 on premises in accordance with an embodiment of the disclosure.

### DETAILED DESCRIPTION

In terms of a general overview, certain embodiments described in this disclosure are directed to systems and methods to scheduling and reserving EV charging ports to optimize charging time, availability, and energy efficiency as between a driver and facility providing charging services. In an exemplary method, a reservation system is provided permitting a driver to reserve all or part of a charging time slot on a particular charging dispenser.

The system will help drivers manage their time efficiently by booking convenient time slots which encourages them to select more efficient, commercial on-premises charging. Generally, reservations are customary for many functions in our society and help reinforce punctual behavior and provide confidence around the timing and delivery of a service.

In an example method, a first computer 107 device sends to a second computer device 500 a message pertaining the availability for a charging device. The message is reviewed on the second computer device for certain attributes pertaining to the reservation request, including the availability of one or more charging devices, existing reservations, time remaining on vehicles presently being charged and the like at 210. The first computer may be a personal communication device belonging to an individual or a driver or on their behalf (a smartphone, for example) 107 or vehicle computer 102 and the second computer may be a control scheduling computer and/or a computer associated with a residence or hotel facility having one or more EV charging devices. 500 Vehicles may be any of various types of vehicles such as, for example, cars, trucks, vans, sports utility vehicles, multi passenger vehicles, such as buses, battery electric vehicles, hybrid vehicles, driver-operated, semi-autonomous, or autonomous vehicles and the like. In the examples used herein, the vehicle can include components such as, for example, a vehicle computer and various sensors and detection devices that are communicatively coupled to the controller scheduling system computer 500 and/or the vehicle computer at 102.

The first computer associated with the driver selects charging time slot option presented by the control scheduling computer 500, which may include identifying information such as plug number, plug type, anticipated charging time and the like. The control scheduling computer 500 then accepts the reservation request and blocks assigned plug and adjusts availability for future requests as may be received at 221.

The first computer associated with the driver selects charging time slot option presented by the control scheduling computer 500, which may include identifying information such as plug number, plug type, anticipated charging time and the like. The control scheduling computer 500 then accepts the reservation request and blocks assigned plug and adjusts availability for future requests as may be received at 221.

In response to the reservation request, the control scheduling computer assigns a charging plug to vehicle based on availability and sends a message to inform the driver that sets trigger to inform the driver it is time to move vehicle to the plug at 222. Multiple charging protocols may be supported by the chargers provided at the facility, including and without limitation, The North American Charging Standard (NACS) which supports both Alternating Current (AC) and Direct Current (DC) charging, the Combined Charging System (CCS) a popular electric vehicle fast charging standard. In addition, these may be deployed in various ratios.

In addition, it will be evident that charging stations having multi-port charging cable availability to provide excess port and charging capacity will be advantages to allow for the charging of one or more vehicles simultaneously, including from a single circuit, which circuit may additionally load balance when multiple cars are utilizing charging ports. Charging times on a per vehicle basis may be determined for each connected vehicle and communicated to the control scheduling computer for reservation and/or completion time purposes to further optimize port availability and scheduling. In addition, one or more charging ports may be kept unused and available to provide excess capacity for incoming reservations in the event of an overstay situation where the charging cable remains connected to the overstay vehicle.

Once the vehicle arrives at the charging station, the vehicle is parked at assigned stall and is connected to the designated charging plug at 225. The control scheduling computer 500 informs the driver's computer that the charging has commenced and an estimated time to completion or achieving a designated charging capacity (such as 80%) charging time at 230.

Upon the completion of charging or reaching the designated charging time, the control scheduling computer provides a notification to the driver 240 that charging is complete per selected charge i.ii.iii.iv.v.vi.level/time, energy loaded, cost for energy or the like. The computer continues to monitor the plug status if the vehicle is not moved after a predetermined time 242. In addition, reminder messages and/or disincentive costs for overstaying are provided to the drivers or valets computer or personal device and/or the facilities computer at 241.

The control scheduling computer monitors for an overstay condition and provides a recommended action for the facility to take, such having the vehicle moved and notifies the driver of the action being taken according to a disincentive or incentive logic at 241. This logic can use current demand, time of day, driver status if known and the like at 210. In one exemplary embodiment according to the present invention, the control scheduler informs property of significant overstay and a recommend action.

At the session end, the vehicle is removed from the plug so it becomes available for a next use 243. The control scheduling computer calculates a final due, including any incurred overstay conditions and charges and invoices the appropriate account depending upon a selected payment method 248.

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “vehicle” as used herein encompasses any of various types of automobiles. Words such as, for example, “owner,” “individual,” “occupant,” “driver,” “customer,” “valet” and “recipient” may be used herein in an interchangeable manner and must be understood to generally refer to a person who is associated with a vehicle. For example, an “owner” of a vehicle may be a “driver” of a vehicle in some situations, or an “customer” of the facility in some other situations, or a “recipient” of a message in yet some other situations. Further, words such as “charging port,” “charging cable,” “dispenser,” “connector” and the like and permutations thereof may also be used herein in an interchangeable manner and are intended to convey the means by which the charger is connected to the vehicle being charged. Additionally, the word “facility” as used herein encompasses apartments, residences, hotels, as well as any other commercial establishment, such as by way of example and without limitation buildings, convenience stores, retail locations and the like that provides charging ports or services. It must be understood that words such as “illustration” “scenario,” “case,” “implementation,” and “situation” are to be understood as examples in accordance with the disclosure. It should be understood that the word “example” as used herein is intended to be non-exclusionary and non-limiting in nature.

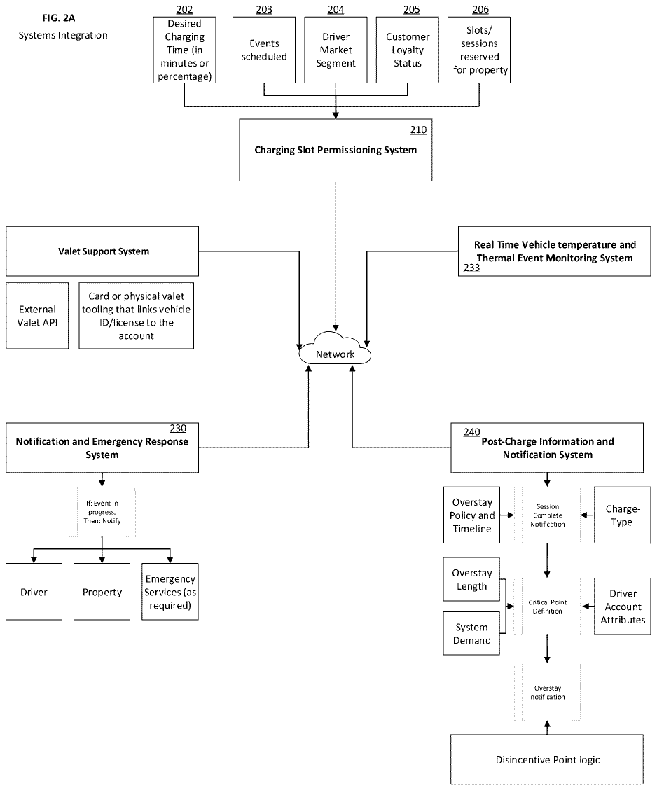

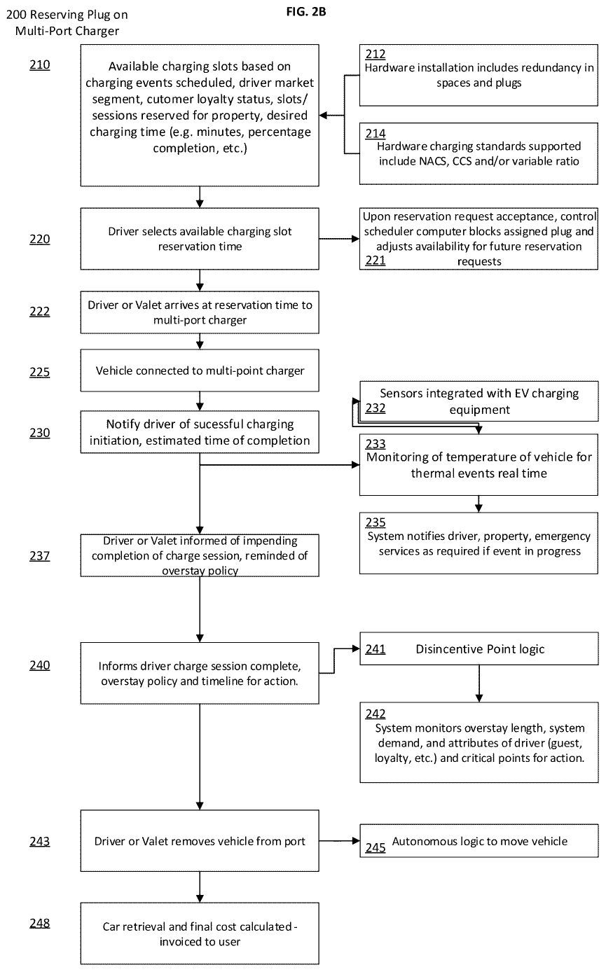

FIG. 2A shows one embodiment of a reservation request executed by the system. The driver initiates a reservation request via a mobile device or facilitation provided application to check availability. The reservation request is transmitted to a control scheduler 500 where the request is processed. The controller scheduler reviews the driver initiated request,210 identifies the driver and reviews as may be the case the drivers brand loyalty status to the facility and/or payment provider or the like 205, market segment 204 and assesses the availability of charging slots based upon existing reservations, 203 current usage number of available overall charging ports and/or available excess charging port capacity and the like for the identified driver.206 The control scheduler then assigns a charging port to the driver comprising according to, for example, a rules engine step 210. For example, the control scheduler may grant a reservation according to a set of rules set which can allocate and determine priority based on driver input such as driver input such as desired charging time 202 (in minutes or desired charge percentage to be attained) and/or information stored in the database such as events scheduled at the facility, 203 slots or sessions otherwise reserved by the facility 206, the driver's loyalty status 205 to a brand and/or payment provider, market segment represented by the driver or vehicle 204, length of stay or residence of the driver at the facility, frequency of use and/or compliance with time protocols including lack of an overstay situation, or on a first come, first served basis, in the order the request is received.

Once the control scheduler assigns a reservation in response to a reservation request and/or calibrated by other attributes the reservation time is transmitted to the driver. In addition, the control scheduler removes the availability of the assigned charging port associated with the transmitted reservation and adjusts the availability for future requests at 221. In addition to the reservation information, the controller scheduler may also provide the driver with information pertaining to the approaching reservation such as time remaining to port availability 660.

A driver provided with the reservation information can select available times presented by the control scheduler and confirms the time slot, plug number, anticipated time on the plug and provide payment information or the like at 210.

If the driver arrives at the designated charging port enters at the predetermined time period or grace period following the notification (step 222), the control scheduler updates charging availability information and the reservations queue stored in the database (step 221 by removing the reservation from the queue. Likewise, if the driver does not fulfill a reservation within a predetermined time or grace period, the scheduling controller updates the queue and provides notification to the driver or the general availability to another driver in the queue (step 221)

The control scheduler may employ a tracking system to detect the movement of the driver based upon the driver's mobile device or vehicles computer and the status of the charging port availability or progress 515. For example, when the driver passenger arrives at the designated charging port in fulfillment of the reservation, a sensor or locator may detect the arrival and transmits the signal to the control scheduler. (Likewise, the scheduling controller may receive a signal when the driver or vehicle disconnects and departs the charging port.) The control scheduler updates the queue based on the information it receives. In the event of an overstayed vehicle, the control scheduler can detect excess charging port capacity and availability and redirect a newly arriving vehicle to an available charging port and away from the charging cable remaining connected to the overstayed vehicle.

In addition to monitoring the status of the reservation and the movement of the driver and/or vehicle passengers, the control scheduler may also monitor the status of the vehicle's battery and systems For example, if there is a temperature or heat event affecting the charging or creating a dangerous situation, a notification can be sent for remedial action, including contacting emergency authorities.

FIG. 2B shows one embodiment of the arrival of the vehicle at the charging station at 222. In response to the notification from the control scheduler, the driver arrives with the vehicle at the assigned stall and connects to the designated charging port at 225. The driver then initiates the charging session via his mobile device or the vehicle's computer at 107, 102. In an alternative embodiment the driver delivers the vehicle to a valet associated with the facility who is notified by the control scheduler of the reservation and reservation attributes. In this embodiment, a valet support module or interface is provided to a valet API associated with the facility. A card, code or similar valet tooling that links the valet to the vehicle identity or driver (as with the driver's delivery of a key fob or code to the valet) for moving of the car in accordance with the reservation and allocated time while the vehicle is in the valet's care.

The control scheduler provides validation checks that the scheduler driver has attached to the port. In addition, the control scheduler notifies the driver that the charging has successfully initiated and provides an estimated time to completion or a predetermined level of charge at 231. In addition, the control scheduler notifies the driver of rules and requirements for moving the vehicle upon the completion of charging 245, which may include financial disincentives or penalties (or incentives to comply) to avoid and overstay situation which may disrupt existing driver reservations at 248.

At the completion of the charging time, the control scheduler detects that the charging is complete and charging is terminated by the control scheduler. At this point, the control scheduler notifies the driver (or valet) that the vehicle charging is complete and the vehicle must be removed from the charging port and the spot freed up at 245. The control scheduler provides updates and notifications of the final cost as well as disincentive costs as will be incurred if the charging port is not made available in a timely manner in accordance to the rules database at 249. In the case of an overstay situation, the control scheduler determines the status of the driver, for example, as an hotel guest or the like and informs the guest they the vehicle needs to be moved. In addition, the facility having the charging station may be notified of the overstay situation and prompted to take action such as towing the vehicle which has overstayed.

In another embodiment, the control scheduler may communicate with the vehicles computer 102 and in the case of a semi-autonomous vehicle, provide commands received by the vehicles computer to have the vehicle moved driverlessly, provided such may be done so safely at 401. In such cases, the semi-autonomous vehicle's computer may cooperate with the control scheduler autonomously move the overstayed vehicle from the overstayed charging port and spot to a second spot that allows for access of the overstayed charging port at 245.

At the end of the session, the control scheduler from the database 540 calculates the final balance due, which may include final energy load and costs. 249 The final invoice is sent, for example to the driver, driver's account, hotel bill, or added to monthly apartment fee or account in the case of a residence depending on the selected method of payment.

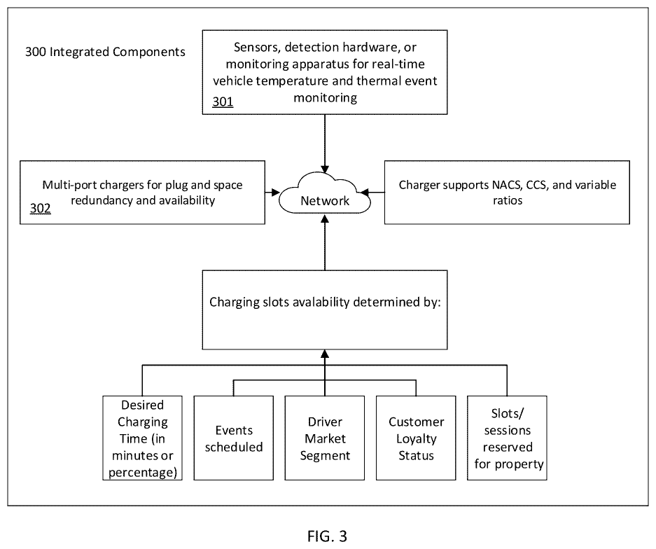

FIG. 3. Illustrates an embodiment which may include an event monitoring module 301, such as a real-time vehicle temperature and thermal event monitoring module communicatively coupled to the vehicles computer, detection hardware and/or sensors, cameras and the like so as to, for example, monitor the temperature of the vehicle for thermal or other events in real time as may effect charging and/or battery performance or an emergency condition requiring attention and provide notification thereof to other networked computers and systems such as the facility or emergency services at 232 233. If an issue is detected, the control scheduler can notify the driver, emergency services, the facility or others as may be dictated by the detected event at 235.

As the system illustrated above provides reservations, management incentives, disincentives, actions and the like improves charging efficiency safety as saves drivers valuable time and increases the use and efficiency of charging devices, particularly DC charging devices by minimizing the time drivers spend on waiting for an available port.

It is understood that the charging reservation system of the invention can be used in many additional places or implementations other than apartments, hotels or other facilities, including without limitation buildings, convenience stores, retail locations and the like that provides charging ports or service or in any place where charging capacity is availability is desired to be optimized.

Charging stations as utilized in the present invention may be any commercially available EV chargers. Preferred examples of the instant invention include multiplug or multiport DC charger such as are commercially available. Mulit-port/plug chargers provide substantial dispenser redundancy and excess capacity in the event of a connected and overstayed vehicle wherein such multi-port chargers having unused dispensers can avoid making the entirety of the charger unusable if a vehicle is not moved at the time when the charge is complete. Moreover, hardware redundancy wherein units are electrically independent and a failure in one unit would not impact the other unit with its two dispensers are preferred to optimize charger utilization by logistical optimization of the scheduling and charging deployment of the instant invention. In addition, loads may be balanced across multiple ports 302 and loads may be balanced across one or more circuits to optimize charging times as well as communicate charging performance on a reservation and/or vehicle type bases.

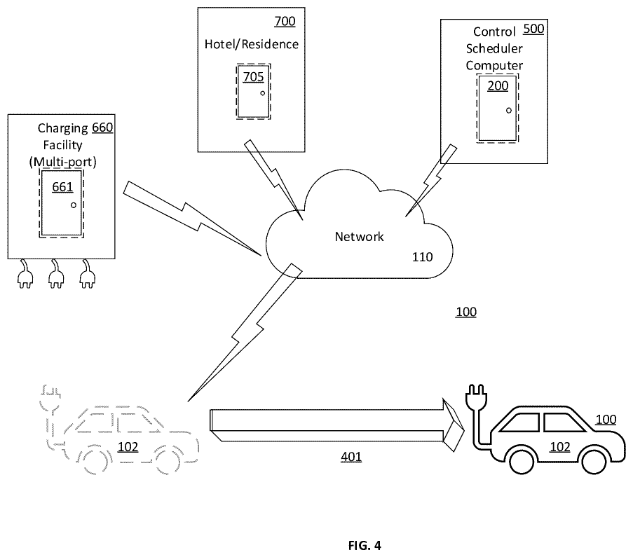

FIG. 4 illustrates a scenario where the vehicle 100 is in an overstay condition following the expiry of the charging session and/or reservation time. If the vehicle is in an overstay condition where it is not disconnected from the charging station and moved so and the expiry of the session so that another vehicle for which a reservation has been made can plug into the available multiport charging receptacle, the control scheduler computer 200 may initiate an overstay protocol procedure to notify the driver or valet that the charging is completed and the vehicle has overstayed the allotted reservation time. In some cases, the vehicle 100 can be a semi-autonomous vehicle and the charging scheduling computer 661, the hotel/residence computer 705 and/or the control scheduler computer 200 may cooperate with the vehicle computer 102 in the semi-autonomous vehicle to autonomously move the vehicle 100 from a first spot to a second spot away from the charging port so that that port is now available for another vehicle charging session at 401. The second spot may, for example, be located inside the property line of the hotel/residence (a garage or a driveway, for example) or anywhere that the vehicle can be safely moved away from the charging port and be retrieved by the driver.

In some other cases, the vehicle 100 can be an autonomous vehicle and the charging scheduling computer 661, the hotel/residence computer 705 and/or the control scheduler computer 200 may cooperate with the vehicle computer 102 to autonomously move the vehicle 110 from the space associated with the charging session to the driveway or garage space associated with the owner or any other pre-designated location to alleviate the overstay condition at 401. The address of such locations to which the vehicle 100 may be permissively moved may be previously stored in a database of the Hotel/Residence Computer, 705, Control Scheduler Computer 200.

In still other cases where the vehicle is overstayed and not disconnected, the control schedule computer 200 may detect an available charging port on the multi-port charger so that a newly arriving vehicle may be charged and redirected to the available charging cable port.

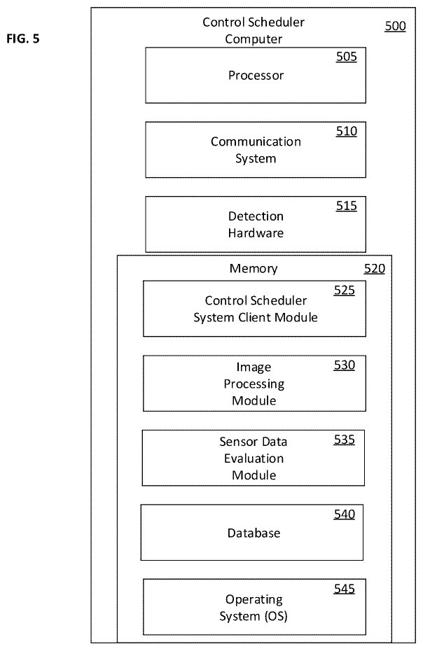

FIG. 5 shows some example components that may be included in the control scheduler system computer 500 in accordance with an embodiment of the disclosure. In this example implementation, the control scheduler system computer includes a processor 505, a communication system 510, detection hardware 515, and a memory 520. The communication system 510 can include a wireless transceiver that allows the control scheduler system computer 500 to communicate with various devices such as, for example, the computer of the facility 705, the computer associated with the charger 661, the personal communication device 107 of the owner 105 or valet 109, and the computer 102 in the electric vehicle 100. The wireless transceiver may use any of various communication formats such as, for example, an Internet communications format, a cellular communications format, a vehicle-to-vehicle (V2V) communication format, and/or a vehicle-to-everything (V2X) communication format to communicate with the various devices, including devices for use with for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

The communication system 510 may also include circuitry for receiving information (signals, images, etc.) from various devices in or associated with the electric vehicle, such as, for example, cameras, and/or various sensors.

The detection hardware 515 can include various sensors and detection devices such as, for example, a camera, an ultrasonic sensor, a radar sensor, a global positioning system (GPS) device, an infrared detector, and a light detection and ranging (LIDAR) device, a temperature detector, heat sensor and the like.

The memory 520, which is one example of a non-transitory computer-readable medium, may be used to store an operating system (OS) 545, a database 540, and attendant code modules such as a control scheduler client module 525, an image processing module 530, and a sensor data evaluation module 535. The memory 520 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer system.

The code modules are provided in the form of computer-executable instructions that can be executed by the processor 505 for performing various operations in accordance with the disclosure.

The database 540 may be used to store various types of information such as, for example, information associated with the driver or owner of the vehicle [105], the charging station, past reservations and/or future reservation requests, events scheduled at the facility, slots or sessions otherwise reserved by the facility, the driver's loyalty status to a brand and/or payment provider, market segment represented by the driver or vehicle, length of stay or residence of the driver at the facility, frequency of use and/or compliance with time protocols including lack of an overstay situation and/or information such as, for example, address and contact information and information concerning payment and the like as may reside in the database540

The control scheduler system client module 525 can include code for executing various actions in accordance with the disclosure. In some scenarios, the control scheduler system client module 525 may utilize the image processing module 530 and/or the sensor data evaluation module 535 to process information provided to the control scheduler system computer by various devices such as, for example, the camera, the thermal sensors and the like. Various image processing techniques may be used for processing images provided by the camera. In an example implementation, the image processing module 530 may incorporate an image processing algorithm modeled on a neural network that is trained to analyze images of various objects and detect, for example, an open slot into which the vehicle may be safely moved at the completion of charging, or an emergency condition warranting attention.

In additional scenarios, the control scheduler system client module 525 executes actions such as sending messages notifying customers when charging is near completion or complete, warning customers about pending overstay charges and subsequent notification that such charges have been incurred, incorporating actual energy cost into charging pricing and communicating this cost to charging customers before charging of the EV.

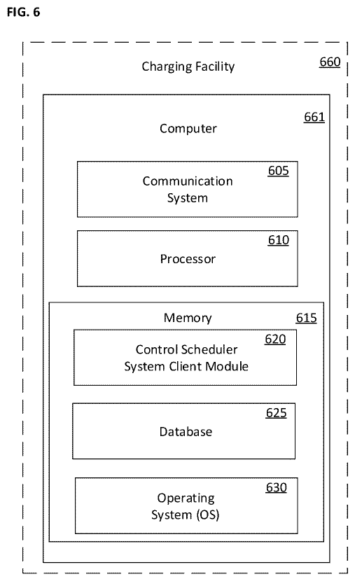

FIG. 6 shows some example components that may be included in the computer 661 of the facility 660 in accordance with an embodiment of the disclosure. In this example implementation, the computer 661 includes a communication system 605, a processor 610, and a memory 615. The communication system 605 can include a wireless transceiver that allows the computer 661 to communicate via the network 110 with various devices such as the control scheduler system computer 500, the vehicle 100 and/or the driver 105 or valet's 109 device 107. The wireless transceiver may use any of various communication formats such as, for example, an Internet communications format or a cellular communications format for communicating with the various devices.

The memory 615, which is another example of a non-transitory computer-readable medium, may be used to store an operating system (OS) 630, a database 625, and associated code modules. The memory 615 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer system. The code modules are provided in the form of computer-executable instructions that can be executed by the processor 610 for performing various operations in accordance with the disclosure.

The system facility master module 620 can include code for executing various actions in accordance with the disclosure, such as the example actions variously described above. In an example implementation, the control scheduler master module 620 executes actions such as, for example, sending messages concerning charging port availability and reservation requests to computers in variously associated with the driver, valet, charging station, facility and vehicles communicating to provide information associated with the scheduling, status and completion of the vehicle charging or redirecting a reservation to an available charging port in an overstay situation. In addition, the module executes exaction in communicative fashion with the facility systems or devices, sensors or computers associated with the driver property including, billing and payment information (such as the hotel billing system, credit card payment and the like, membership system for multi-family building residents allowing priority booking for members, preferential scheduling based on customer status, membership level and the like, hotel reservations systems and/or valet and parking systems and key fob recognition system allowing immediate access and payment.

In the above disclosure, reference has been made to the accompanying drawings, which form a part hereof, which illustrate specific implementations in which the present disclosure may be implemented. It is understood that other implementations may be utilized, and structural changes may be made without departing from the scope of the present disclosure. References in the specification to “one embodiment,” “an embodiment,” or “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 505 or the processor 610, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not in function.

At least some embodiments of the present disclosure have been directed to computer program products comprising such logic (e.g., in the form of software) stored on any computer-usable medium. Such software, when executed in one or more data processing devices, causes a device to operate as described herein.

While embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching.

Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a recurrent neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

Some embodiments involve the use of one or more electronic processing or computing devices. Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processor, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processing (DSP) device, an application specific integrated circuit (ASIC), and other programmable circuits or processing devices capable of executing the functions described herein, and these terms are used interchangeably herein. The above are examples only, and thus are not intended to limit in any way the definition or meaning of the terms processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal. Alternatively, a floppy disk, a compact disc-read only memory (CD-ROM), a magneto-optical disk (MOD), a digital versatile disc (DVD), or any other computer-based device implemented in any method or technology for short-term and long-term storage of information, such as, computer-readable instructions, data structures, program modules and sub-modules, or other data may also be used. Therefore, the methods described herein may be encoded as executable instructions, e.g., “software” and “firmware,” embodied in a non-transitory computer-readable medium. Further, as used herein, the terms “software” and “firmware” are interchangeable, and include any computer program stored in memory for execution by personal computers, workstations, clients and servers. Such instructions, when executed by a processor, cause the processor to perform at least a portion of the methods described herein.

The systems and methods described herein are not limited to the specific embodiments described herein, but rather, components of the systems and/or steps of the methods may be utilized independently and separately from other components and/or steps described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

As used herein, an element or step recited in the singular and proceeded with the word “a” or “an” should be understood as not excluding plural elements or steps unless such exclusion is explicitly recited. Furthermore, references to “one embodiment” of the present disclosure or “an example embodiment” are not intended to be interpreted as excluding the existence of additional embodiments that also incorporate the recited features.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer implemented system for increasing EV charging efficiency and use comprising:
a vehicle;
a charging port on a multi-port charging apparatus
a first computer; and
a second computer, the second computer comprising:
a memory that stores computer-executable instructions; and
a processor configured to access the memory and execute the computer-executable instructions to perform operations comprising:
sending, to the first computer, a first message comprising a request for a reservation for an available charging port to charge the vehicle;
detecting the availability of available charging port time periods;
presenting available charging port time periods to the first computer;
reserving a charging port time slot in response to a message from the second computer;
charging the vehicle;
detecting, by the first processor that the connected vehicle is in an overstay situation;
redirecting, by the first processor, a second reservation for the charging port in the overstay situation to an available port on the multi-port charging apparatus;
communicating with a third computer onboard the vehicle to have the vehicle moved driverlessly.

2. (canceled)

3. (canceled)

4. (canceled)

5. The system according to claim 1, further comprising:
detecting, by the first processor the connection of the vehicle to the EV charging port.

6. The system according to claim 1, further comprising:
sending, by the first processor to the second processor, a message that the vehicle has reached a predetermined charge level.

7. The system according to claim 1, further comprising:
sending, by the first processor to the second processor, a message that the vehicle has exceeded the time allotted for the reservation and is in an overstay situation.
